(19) United States
(12) Patent Application Publication
(10) Pub. No.: US 2024/0167711 A1
(43) Pub. Date: May 23, 2024

(54) SIMULATION SYSTEM AND METHOD FOR PREDICTING HEATING AND COOLING LOAD IN BUILDING

(71) Applicant: ECOSIAN CO, LTD., Seoul (KR)

(72) Inventors: Tae Dong LEE, Seoul (KR); Won Jang PARK, Seoul (KR); Min Ho CHOI, Goyang-si (KR); Soo Hyun YANG, Gwangmyeong-si (KR); Moo Kyung SEO, Seoul (KR); Han Sung CHOI, Seoul (KR); Hye Mi LIM, Incheon (KR); Ji Hun PARK, Seoul (KR); So Jeong PARK, Seoul (KR); Ki Bum HAN, Seoul (KR); Hyeong Jae JEON, Incheon (KR)

(21) Appl. No.: 18/370,391

(22) Filed: Sep. 19, 2023

(30) Foreign Application Priority Data
Nov. 18, 2022 (KR) 10-2022-0155312

(51) Int. Cl. F24F 11/46; F24F 11/52; G05B 15/02

(52) U.S. Cl. CPC F24F 11/46; F24F 11/52; G05B 15/02

(57) ABSTRACT

The simulation system for predicting heating and cooling loads of a building comprises the collection unit collecting measurement data of a target building from a BEMS, the identification unit identifying indoor and outdoor temperature, humidity, and insolation measured in the building in real time based on RTS method, the correlation derivation unit deriving a correlation between energy usage based on the BEMS measurement data collected by the collection unit and the cooling and heating loads according to indoor and outdoor temperature, humidity, and insolation identified by the identification unit, the simulation unit predicting a change in cooling and heating loads according to a change in at least one of pieces of measurement data based on the correlation derived from the correlation derivation unit to perform a simulation, and the information provision unit providing a simulation result from the simulation unit in a visible form to a user terminal.

### CROSS-REFERENCE TO RELATED APPLICATION(S)

This application claims priority to Korean Patent Application No. 10-2022-0155312 filed in the Korean Intellectual Property Office on Nov. 18, 2022, the disclosure of which is incorporated by reference herein in its entirety.

### STATEMENT REGARDING KOREAN GOVERNMENT-SPONSORED RESEARCH OF DEVELOPMENT

This invention was made with Korean government support under ECOSIAN CO., LTD.'s Project (Project ID.: 1415180006; Project No. 20212020900090; Research Title: DEVELOPMENT OF ENERGY DEMAND MANAGING CORE TECHNOLOGY; Project Title: Development of digital twin platform and business model linked to domestic and foreign technical standards that support energy management and optimization of energy-intensive buildings; Research Period: May 1, 2021 through Apr. 30, 2024;) sponsored by the Ministry of Trade, Industry and Energy and managed by Korea Institute of Energy Technology Evaluation and Planning, with a contribution ratio of 100% to ECOSIAN CO., LTD.

### TECHNICAL FIELD

The present disclosure relates to a simulation system and method for predicting heating and cooling loads in a building and more particularly, a simulation system and method for predicting heating and cooling loads in a building which collects pieces of measurement data from the building energy management system (BEMS), including energy consumption and management data of electricity, air conditioning, crime prevention, and disaster prevention facilities of the target building, thereby performing a simulation for predicting heating and cooling loads in a building.

### DISCUSSION OF RELATED ART

Existing systems (building energy management system, BEMS) aim to manage energy demand through measurement and analysis of energy consumption in target buildings, but it is difficult to identify in detail the source or cause of energy use.

In general, the peak power demand of the power grid is generated by the cooling power demand in the summer and the heating power demand accounts for a large portion in the winter.

Current methods for managing such peak power demand are as follows:
i) a method of installing a maximum power demand management device (e.g., demand controller, DC) in the customer's building to cut off the power of some power devices so as not to exceed the building's peak power;
ii) a method of directly controlling the cycling of stopping and starting the operation of the customer's cooling system periodically by the power company; and
iii) a method of reducing their own power load during peak hours by participating in the autonomous power-saving system by customers.

In particular, a technical method for managing the power load of the cooling system of a building among power loads is as follows:
i) a method of periodically on-off controlling the operation of the outdoor unit;
ii) a method of continuously proportionally controlling the compressor operating load factor of the outdoor unit of the air conditioner through inverter control;
iii) a method of controlling the number of split operation or periodic on-off, which operates and stops for air-conditioning and heating equipment, which is an indoor unit; and
iv) a method of controlling the indoor set temperature of the building

However, there is a problem in that the power load control operation focused on the purpose of reducing cooling and heating power inevitably leads to an increase in the indoor temperature in cooling or a decrease in indoor temperature in heating, thereby greatly reducing the satisfaction of the comfort level of the room temperature to accumulate residents' dissatisfaction with air conditioning and heating control, so that it acts as a factor that hinders the residents' steady participation in the demand management program.

Meanwhile, current methods for calculating the heating and cooling heat load of the building include the annual load calculation method used for total energy consumption analysis such as life-cycle cost (LCC) analysis and the method for calculating the maximum load used for selecting equipment capacity during building design. As a method for calculating the maximum load, the total equivalent temperature difference/time averaging (TETD/TA) method and the transfer function method (TFM), which expresses the load behavior as a conduction transfer function and a room transfer function, have been proposed.

Further, the cooling load temperature differential/cooling load factors (CLTD/CLF) method was developed for the use of a room that can be used simply by simplifying the value in a table instead of calculating the complicated function of TFM, and the cooling load temperature differential/solar cooling load/cooling load factors (CLTD/SCL/CLF) method, which is a change of the CLTD/CLF method, is suggested and used.

The radiant time series (RTS) method is a new simple method for performing design heating and cooling load calculations derived from the heat balance (HB) method, and it can replace other simple methods such as the TFM method, CLTD/CLF method, and TETD/TA method.

The RTS method multiplies the hourly heat gain by a 24-hour time series to represent the conductive time lag and radiative time lag effects. Multiplying the time series distributes the heat gain over time. The series coefficients, called radiative time components and conductive time components, are obtained using the thermal equilibrium method.

The radiative time components reflect the percentage of radiant heat gain, that is, the cooling load for the current hour over the total radiant heat gain.

The conductive time components reflect the percentage of heat gain, that is, the cooling load for the current hour over the heat gain from the outer wall or roof. By definition, the sum of each radiative or conductive time series must add up to 100%.

### SUMMARY

The present disclosure was derived from such a technical background, and an object of the present disclosure is to provide the simulation system and method for predicting heating and cooling loads of a building which uses indoor and outdoor temperature, humidity, and insolation measured in a building in real time to calculate the actual cooling and heating loads of the target building in units of time, thereby visualizing and displaying the resultant, and derives simulation results to enable load prediction when the envelope performance, practicality, and indoor set temperature of the target building are changed.

The present disclosure for achieving the above object includes the following configuration.

The simulation system for predicting the heating and cooling loads of a building according to an embodiment of the present disclosure comprises the collection unit configured to collect measurement data including energy usage, electricity, air conditioning, crime prevention, and disaster prevention facility management data of a target building from a building energy management system (BEMS), the identification unit configured to identify indoor and outdoor temperature, humidity, and insolation measured in the building in real-time based on radiant time series (RTS) method, the correlation derivation unit configured to derive a correlation between energy usage based on the BEMS measurement data collected by the collection unit and the cooling and heating loads according to indoor and outdoor temperature, humidity, and insolation identified by the identification unit, the simulation unit configured to predict a change in cooling and heating loads according to a change in at least one of pieces of measurement data based on the correlation derived from the correlation derivation unit to perform a simulation, and the information provision unit configured to provide a simulation result from the simulation unit in a visible form to a user terminal.

Further, the method for performing a simulation system for predicting the heating and cooling loads of a building according to an embodiment of the present disclosure comprises comprises the collecting step for collecting pieces of measurement data including energy usage, electricity, air conditioning, crime prevention, and disaster prevention facility management data of a target building from a building energy management system (BEMS). the identifying step for identifying indoor and outdoor temperature, humidity, and insolation measured in the building in real time based on radiant time series (RTS) method, the correlation deriving step for deriving a correlation between energy usage based on the BEMS measurement data collected by the collecting step and the cooling and heating loads according to indoor and outdoor temperature, humidity, and insolation identified by the identifying step, the simulating step for predicting a change in cooling and heating loads according to a change in at least one of pieces of measurement data based on the correlation derived from the correlation deriving step to perform the simulation, and the information providing step for providing a simulation result from the simulating step in a visible form to a user terminal.

The present disclosure derives effects for providing the simulation system and method for predicting heating and cooling loads of a building which uses indoor and outdoor temperature, humidity, and insolation measured in a building in real time to calculate the actual cooling and heating loads of the target building in units of time, thereby visualizing and displaying the resultant, and derives simulation results to enable load prediction when the envelope performance, practicality, and indoor set temperature of the target building are changed.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is an exemplary view showing the configuration of the simulation system for predicting heating and cooling loads according to an embodiment of the present disclosure;

FIG. 2 is an exemplary view of a screen on which an information providing unit provides a result of monitoring cooling and heating loads according to an embodiment of the present disclosure;

FIGS. 3, 4, and 5 are exemplary views of screens on which the information providing unit provides the simulation of predicting heating and cooling loads according to an embodiment of the present disclosure; and

FIG. 6 is a flowchart of the simulation method for predicting heating and cooling loads of a building according to an embodiment of the present disclosure.

### DETAILED DESCRIPTION OF EXEMPLARY EMBODIMENTS

It should be noted that technical terms used in the present disclosure are only used to describe specific embodiments and are not intended to limit the present disclosure. Further, technical terms used in the present disclosure should be interpreted in terms commonly understood by those of ordinary skill in the art to which the present disclosure belongs, unless otherwise defined in the present disclosure, and it should not be interpreted in an overly comprehensive sense or an overly narrow sense.

Hereinafter, preferred embodiments according to the present disclosure are described in detail with reference to the accompanying drawings.

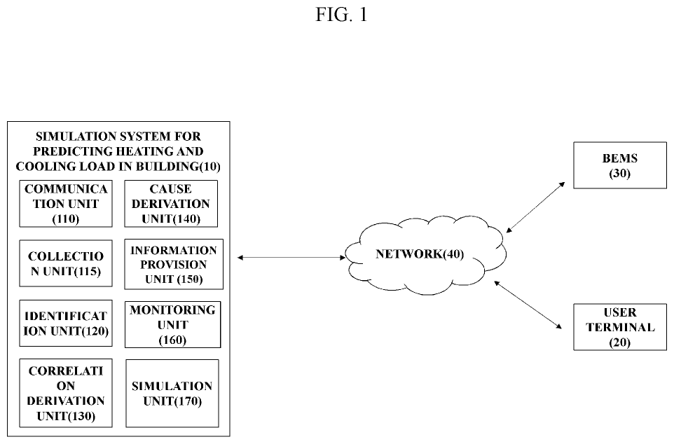

FIG. 1 is an exemplary view showing the configuration of the simulation system for predicting heating and cooling loads according to an embodiment of the present disclosure.

The simulation system for predicting heating and cooling loads of a building 10 according to an embodiment calculates, visualizes, and displays the actual cooling and heating loads of the target building in units of time using indoor and outdoor temperature, humidity, and insolation measured in the building in real time based on the radiant time series (RTS) method, which can calculate load by time. The simulation system for predicting heating and cooling loads of a building 10 according to an embodiment may be installed in a building energy management system (BEMS), thereby being implemented in a module configured on an hourly/day/monthly basis. However, it is not limited thereto.

Further, the simulation system for predicting the heating and cooling loads of a building according to an embodiment provides a simulation function for predicting the annual cooling and heating loads when the load influencing factor of the target building is changed. Specifically, for the envelope insulation performance according to the design base year of the target building, the annual cooling and heating load comparison value is calculated when the envelope insulation performance is changed according to the Evolution of Building Energy Code (all standards revised from 2001 to 2017). Further, when the use of a room in the target building is changed, the annual cooling and heating loads comparison value is calculated. Further, the internal heat sources (e.g., lighting power, number of occupants, heating device calorific value) vary depending on the use of a room, and the load when the heat source is changed is calculated.

Further, when the indoor set temperature of the target building is changed, the annual cooling and heating loads comparison value is calculated. The indoor set temperature values of the target building are a major factor in calculating the cooling and heating loads, and a method for finding the optimal indoor set temperature value can be provided by comparing the load values according to the change in the set temperature values.

A building energy management system (BEMS) is a system that utilizes IT technology in buildings to manage various building facilities such as electricity, air conditioning, crime prevention, and disaster prevention. It aims to manage various facilities used in the building, creating a pleasant environment, reducing energy and labor costs, as well as extending the life of the building. It is being standardized by energy conservation in buildings and community systems (ECBCS) of the International Energy Agency (WA) under the Organization for Economic Co-operation and Development (OECD).

The simulation system for predicting heating and cooling loads of a building 10 according to an embodiment provides a function of analyzing a cause of energy use.

Detailed cooling and heating loads that may occur due to internal and external factors such as climate and indoor heat sources can be calculated based on BEMS measurement data to identify the cause of the high consumption of the cooling and heating energy in the target building.

At this time, cooling and heating loads are generated by internal and external factors, respectively, and can be classified into two types.

They can be classified as external loads, which are cooling and heating loads affected by climate and external factors such as insolation and outdoor air temperature and humidity (loads from exterior walls, windows, and roofs) and internal loads, which are cooling and heating loads affected by heat gain and loss inside the building (internal structure, lighting, electric heating, number of occupants, load due to infiltration air).

The cause of the high use of cooling and heating energy can be identified as the load generating element in the target building, which includes the outer envelope of the target building such as exterior walls, windows, and roofs) and internal heat sources such as inner wall, ceiling, and floor structures, lighting, heating devices, occupancy, and heat sources generated by intrusion and outdoor air. In other words, as the load influencing factors of the target building are calculated in real-time, the manager can come up with a plan to improve the performance of the aging building envelope or to efficiently operate the cooling and heating system by identifying sections with heavy load by time zone.

As shown in FIG. 1, the simulation system for predicting heating and cooling load in a building 10 includes a communication unit 110, a collection unit 115, an identification unit 120, a correlation derivation unit 130, a cause derivation unit 140, a simulation unit 170, an information provision unit 150 and a monitoring unit 160.

The communication unit 110 communicates with any internal component or at least one external terminal through a wired/wireless communication network. Here, wireless Internet technologies include wireless LAN (WLAN), digital living network alliance (DLNA), wireless broadband (WiBro), world interoperability for microwave access (WiMAX), high speed downlink packet access (HSDPA), high speed uplink packet access (HSDPA), IEEE 802.16, long term evolution (LTE), long term evolution-advanced (LTE-A), wireless mobile broadband service (WMBS), etc., and the communication interface 110 transmits and receives data according to at least one wireless Internet technology within a range including Internet technologies not listed above.

Further, short-range communication technologies may include Bluetooth, radio frequency identification (RFID), infrared data association (IrDA), ultra-wideband (UWB), ZigBee, near field communication (NFC), ultrasound communication (USC), visible light communication (VLC), Wi-Fi, Wi-Fi Direct, and the like may be included. Further, wired communication technologies may include power line communication (PLC), USB communication, Ethernet, serial communication, optical/coaxial cables, and the like.

The at least one external terminal may be the user terminal 20 or the building energy management system (BEMS) 30.

In addition to a communication method utilizing a communication network (for example, mobile communication network, wired Internet, wireless Internet, broadcasting network) that the network may include, short-range wireless communication between devices may also be included. For example, the network 40 may include one or more arbitrary networks such as a personal area network (PAN), a local area network (LAN), a campus area network (CAN), a metropolitan area network (MAN), a wide area network (WAN), a broadband network (BBN). and the Internet. Further, the network 40 may include any one or more of network topologies including a bus network, a star network, a ring network, a mesh network, a star-bus network, a tree or a hierarchical network, and the like, but is not limited thereto.

The user terminal 20 can be applied to various terminals such as a smart phone, a portable terminal, a mobile terminal, a foldable terminal, a personal digital assistant (PDA), a portable multimedia player (PMP) terminal, a telematics terminal, a navigation terminal, a personal computer, a notebook personal computer, a slate personal computer, a tablet personal computer, an Ultrabook, wearable device including, for example, smartwatch, smart glass, head mounted display (HMD), WiBro terminal, Internet protocol television (IPTV), a smart television, a digital broadcasting terminal, an audio video navigation (AVN) terminal, an audio/video (A/V) system, a flexible terminal, a digital signage device, and the like.

In one embodiment, the user terminal 20 is interpreted to include a terminal device possessed by a manager who performs overall management of a target building.

The collection unit 115 collects pieces of measurement data including energy usage, electricity, air conditioning, crime prevention, and disaster prevention facility management data of a target building from a building energy management system (BEMS).

In one embodiment, the collection unit 115 collects the building energy management system (BEMS) including heat sources generated by the target building's envelope including exterior walls, windows, and roofs, inner wall, ceiling, and floor structures, lighting, heating devices, occupants, and intrusion outdoor air. However, it is not limited thereto, and the collection unit 115 is interpreted to encompass all technical configurations of collecting various measurement data that may have an effect on identifying the cooling and heating loads of a target building.

The identification unit 120 identifies indoor and outdoor temperature, humidity, and insolation measured in the building in real time based on the radiant time series (RTS) method.

The identification unit 120 may identify indoor and outdoor temperature, humidity, and insolation for each physically divided unit within the building.

The RTS method multiplies the hourly heat gain by a 24-hour time series to represent the conductive time lag and radiative time lag effects. Multiplying the time series distributes the heat gain over time. The series coefficients, called radiative time components and conductive time components, are obtained using the thermal equilibrium method.

The radiative time components reflect the percentage of radiant heat gain, that is, the cooling load for the current hour over the total radiant heat gain. The conductive time components reflect the percentage of heat gain, that is, the cooling load for the current hour over the heat gain from the outer wall or roof. By definition, the sum of each radiative or conductive time series must add up to 100%.

The RTS method allows calculation of conducted heat gain, splitting all heat gain into radiative and conductive parts, and conversion of radiant heat gain to cooling load.

The correlation derivation unit 130 derives a correlation between energy usage based on the BEMS measurement data collected by the collection unit 115 and the cooling and heating loads according to indoor and outdoor temperature, humidity, and insolation identified by the identification unit 120.

For example, when the cooling and heating loads at a specific time or in a specific space is higher than the average load value in a building by a predetermined amount, the collection unit 115 identifies the collected measurement data for the corresponding space.

Further, the correlation derivation unit 130 may derive a correlation of cooling and heating loads according to indoor and outdoor temperature and humidity and insolation based on energy saving design standards that have been previously databased.

In another aspect, the cause derivation unit 140 derives the causal factor of the cooling and heating loads based on the correlation derived by the correlation derivation unit 130.

Factors that affect real-time cooling and heating loads are identified based on the data measured in the target building, thereby identifying the causes of heating and cooling energy use and providing quantitative data on energy consumption by cause.

For example, the cause derivation unit 140 first identifies the average cooling and heating loads of the entire building and classifies areas that are higher or lower than the average cooling and heating loads according to the distribution of the cooling and heating loads for each zone.

Further, the causal factor may be derived by comparing the measurement data of the corresponding area, which is higher or lower than the average cooling and heating load, with the measurement data of other areas.

For example, when the heating load of unit 1 on the second floor is lower than other areas of the building, measurement data including energy consumption, electricity, air conditioning, crime prevention, and disaster prevention facility management data, in the corresponding area are compared with measurement data in other areas to compare data indicating low electricity consumption. Then, in this case, it may be determined that the room is vacant through the fact that the electricity consumption of the corresponding room is low, and it may be determined that the room is vacant due to the low heating load.

Further, for example, when the cooling load of unit 2 on the third floor is higher than other zones, it may be recognized that the inner wall, ceiling, and floor structure of the corresponding area is of a different type from that of other areas to derive these issues as a causal factor.

Further, the cause derivation unit 140 may derive a corresponding factor as a cause that uses a lot of cooling and heating energy when the cooling and heating loads is different according to the material of the outer wall, window, or roof of the building. Managers can recognize deterioration in the performance of the old building's envelope and improve the performance of the old building's envelope or identify areas with heavy load by time zone to prepare a plan for efficiently operating the cooling and heating system.

In another aspect of the present disclosure, the simulation system for predicting the heating and cooling loads of a building 10 according to an embodiment continuously collects monitoring information on the correlation between the causal factor identified by the identification unit 120 and the cooling and heating loads and deep-learns the collected data as learning data.

Further, deep-learning artificial intelligence technology is introduced to improve the analysis accuracy in deriving the causal factor that causes the cooling and heating loads, and furthermore, to improve the accuracy of deriving an alternative to lower the cooling and heating loads.

Further, the air-conditioning and heating control system may be driven based on the deep learning contents. For example, when the temperature of a room facing north is lower than that of a room facing south, the boiler can be controlled to operate for a longer period of time in the room facing north than in the room facing south. Further, when the temperature of the top floor is higher than that of other floors in a building, it may control the cooling system of the top floor to operate longer than the other floors.

The information provision unit 150 provides the user terminal 20 with the correlation result derived from the correlation derivation unit and the cause element information of the cooling and heating loads derived from the cause derivation unit 140.

In one aspect, the information provision unit 150 zones a target building into physical spatial units, identifies a change in cooling and heating loads by time zone for each zoned spatial unit, and provides the information to the user terminal 20, and a cooling and heating loads ratio to the average cooling and heating load of the entire target building for each zoned spatial unit is calculated and provided.

It may be determined whether the cooling and heating loads are relatively high or low compared to other spaces in the building. In particular, accuracy can be improved by comparing it with the heating and cooling loads of other areas in the same building at the same time of day.

Further, the information provision unit 150 may identify the daily cooling and heating loads for each time period, identify a physical area with large cooling and heating loads, and provide time information at which the cooling and heating loads is maximum or minimum. Further, the information provision unit 150 identifies the cooling and heating loads of different physical areas in the same time period, identifies the maximum or minimum physical area, and provides the corresponding information to the user terminal 20.

In an additional aspect of the present disclosure, the information provision unit 150 may suggest ways to improve energy efficiency and lower the cooling and heating loads, such as replacing interior wall cladding materials with specific types or changing windows and doors, based on information collected from other areas or other buildings, for the part derived as the causal factor identified by the cause derivation unit 140. Further, it may suggest methods such as replacing an aged building envelope or replacing a lighting device with a lighting device that generates less heat.

In another aspect, the simulation system for predicting heating and cooling loads in building 10 according to an embodiment collects the causal factors of the cooling and heating loads for at least one building to identify a material type or brand which is effective for improving energy efficiency.

The information provision unit 150 may recommend efficient window sizes or products suitable for a target building, particularly in areas with a high cooling and heating load. In other words, it may provide data that can be used as a basis for building data to lower the cooling and heating loads at the time of architectural design in the building construction process.

Further, it may identify the energy efficiency of each floor of a building and calculate and provide energy efficiency statistics according to the building arrangement or the number of floors out of the total number of floors of the building.

In one aspect of the present disclosure, the monitoring unit 160 periodically monitors a change in cooling and heating loads according to a change in a causal factor of the cooling and heating loads identified by the cause derivation unit 140. In other words, it may not only identify the causal factor of the cooling and heating loads, but also identify the continuous influence of the corresponding causal factor on the cooling and heating loads.

The cooling and heating loads change monitoring cycle may be applied in various ways by being set by the user, such as daily, weekly, or monthly.

At this time, the monitoring unit 160 calculates the amount of change in cooling and heating loads for the amount of change in the causal factor of the cooling and heating loads, thereby deriving a quantitative relationship.

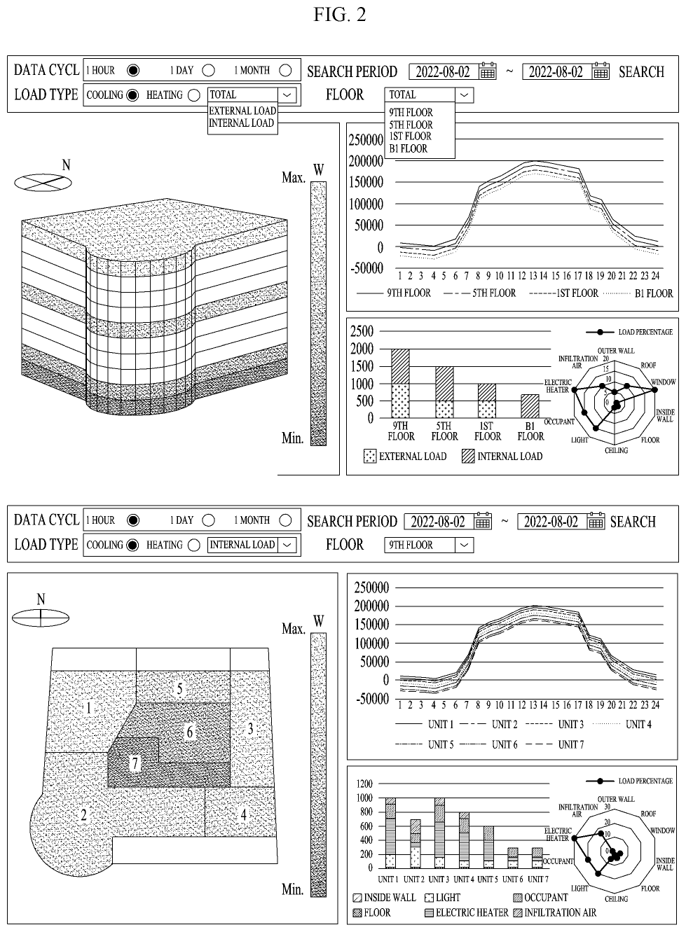

FIG. 2 is an exemplary view of a screen on which an information providing unit provides a result of monitoring cooling and heating loads according to an embodiment of the present disclosure.

The user accesses a cooling and heating monitoring and simulation service providing an application or website running in the user terminal 20 to select target building information, data period, and search period. The data period may be hourly, daily, weekly, or monthly.

The load type is selected. One of the load types of cooling and heating loads, internal and external, or total load may be selected.

Then, the floor information to be searched in the target building is selected. Further, the entire building or a specific floor to identify the heating and cooling loads for the selected floor may be selected. At this time, the identification unit 120 according to an embodiment calculates and identifies the real-time cooling and heating loads of the target building based on an algorithm.

When condition information is input, the results of cooling and heating loads for some or all areas of the target building that meet the conditions are provided as visible data.

That is, as shown in FIG. 2, the cooling and heating loads results for each data period, load type, and all floors or each floor may be calculated and provided as a 3D model heat map. According to the search conditions, the cooling and heating loads of the target building are calculated in real-time and provided in highly readable data. Further, according to search conditions, cooling and heating loads may be provided in physically divided area units in various ranges for each floor and room of the target building, or loads may be calculated and compared for each detailed influencing factor. The load calculation and impact of each detailed influencing factor of the target building is compared to provide the comparison result in highly readable data.

The simulation unit 170 simulates a change in cooling and heating loads according to a change in at least one of the pieces of measurement data based on the correlation derived from the correlation derivation unit 130.

In one embodiment, the simulation unit 170 predicts and simulates a change in cooling and heating loads when the envelope performance, the use of a room, and the indoor set temperature of the target building are changed.

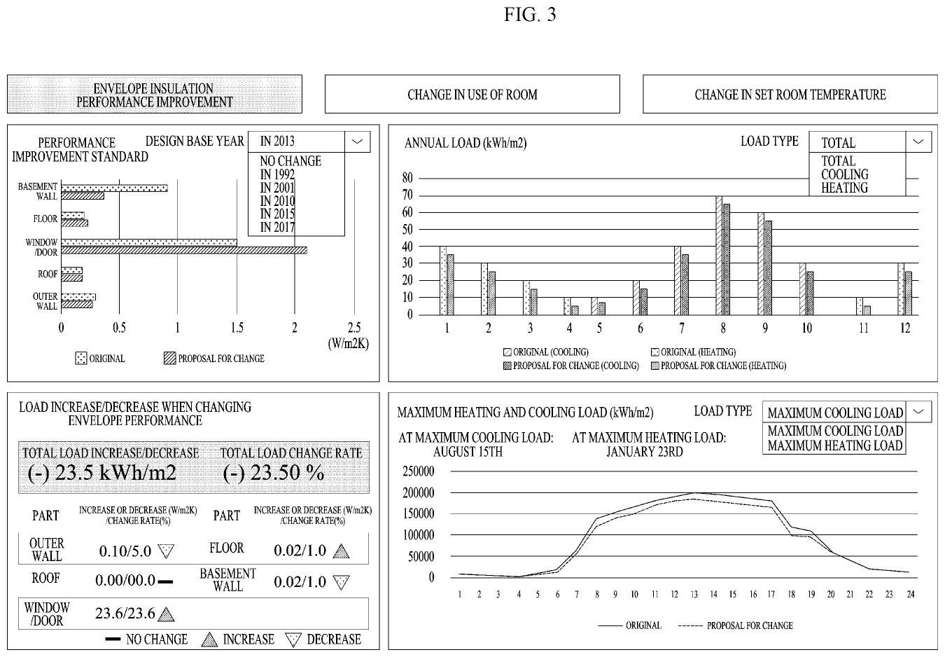

FIGS. 3, 4, and 5 are exemplary views of screens on which the information providing unit provides the simulation of predicting heating and cooling loads according to an embodiment of the present disclosure.

Specifically, FIG. 3 is an exemplary view of a simulation screen for predicting cooling and heating loads when improving the insulation performance of the envelope.

The simulation unit 170 calculates a comparison value of annual cooling and heating loads according to the performance change in the outer insulation of the target building according to building energy saving design standard to perform the simulation to predict the annual cooling and heating loads. Further, the performance improvement simulation may be provided while changing the envelope performance standard of the target building according to the building energy saving design standard-based design standard year.

Further, the original envelope performance standard and the changed envelope performance standard of the target building can be displayed together in different colors to facilitate comparison.

At this time, a comparison result may be provided by further reflecting on various factors that may act on the envelope change. Specifically, simulation results may be provided to allow performance comparison according to envelope insulation construction options such as envelope insulation type or insulation thickness.

In other words, the change in envelope performance of the target building and the annual cooling and heating loads according to the change in envelope performance is calculated, thereby providing the calculation as a simulation result. The annual cooling and heating loads calculation function and selective search function according to cooling and heating loads or total load are provided.

Further, when the envelope performance standard of the target building is changed, the load increase or decrease for each internal and external structure is calculated, and the result is provided, and the load calculation function for each hour of the day at the time of the maximum cooling and heating loads of the target building and the selective search function for each cooling and heating loads may be provided.

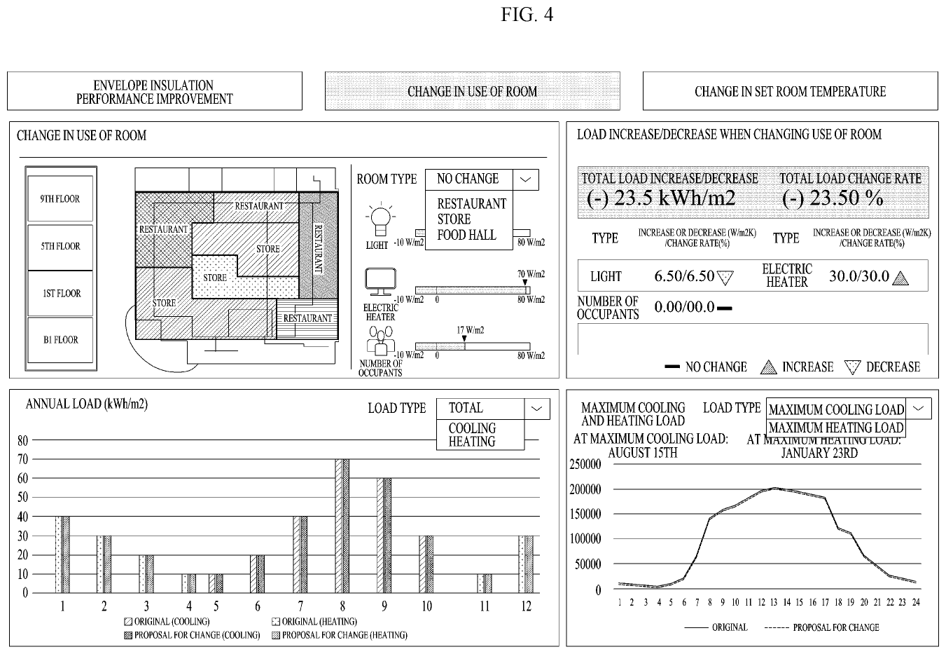

FIG. 4 is an exemplary view of a simulation screen for predicting cooling and heating loads when the use of a room of a target building is changed according to an embodiment of the present disclosure.

The simulation unit 170 calculates a comparison value of annual cooling and heating loads according to the performance change in the internal heating source of the building by identifying at least one of the pieces of data on lighting power, number of occupants, and calorific value of an electric heating device to perform the simulation to predict the annual cooling and heating loads.

As shown in FIG. 4, a physically divided range of the target building, that is, a specific floor and room is selected, and information on room type change is input. This may be applied differently depending on the target building. In detail, lighting information, heating device information, and occupancy information are additionally input as internal heating element values according to the change in the room type of the target building. However, it is not limited thereto, and various factors that may affect the cooling and heating loads of the indoor space may all be included.

According to the user's selection, the annual cooling and heating loads and selectively inquire according to the cooling and heating loads or total loads are calculated.

When changing the use of a room, the load increase or decrease due to changes in lighting, number of occupants, and heating value of electric heaters may be calculated. Further, a load calculation function for each hour of the day at the time of the maximum cooling and heating loads of the target building and a selective search function for each cooling and heating loads are provided.

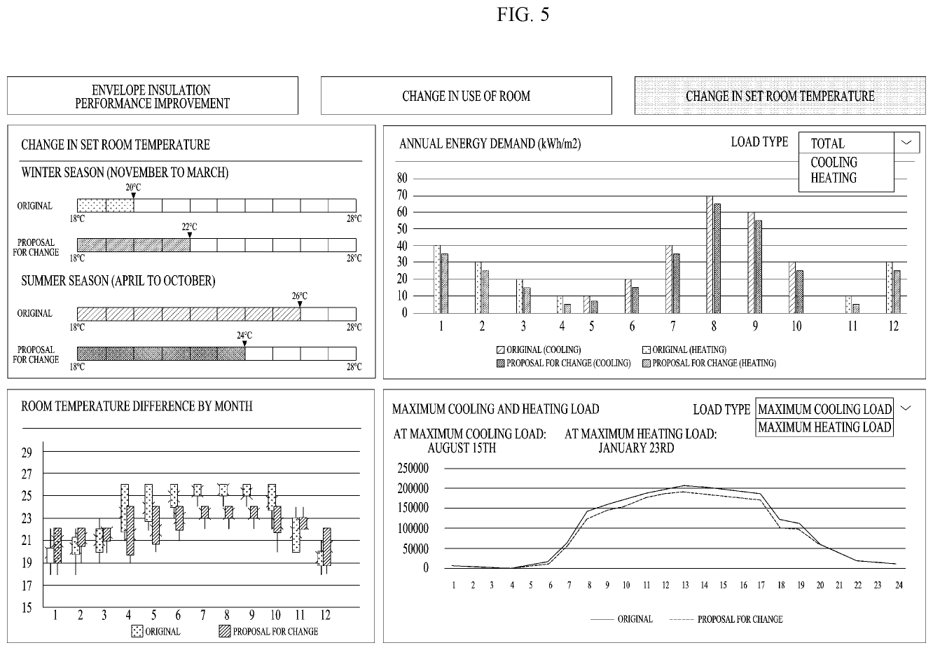

FIG. 5 is an exemplary view of a simulation screen of predicting cooling and heating loads when the indoor set temperature of a target building is changed according to an embodiment of the present disclosure.

The simulation unit 170 calculates a comparison value of annual cooling and heating loads according to the change in the indoor set temperature value of the building to perform the simulation to predict the annual cooling and heating load.

As shown in FIG. 5, in one embodiment, information on changing the indoor set temperature is input according to user selection. Accordingly, the annual cooling and heating loads according to the indoor set temperature of the target building may be calculated.

Further, according to the calculation of the annual cooling and heating loads and the selection according to the cooling and heating loads or total loads, the annual energy demand per month is calculated for each set temperature to provide the results as a graph.

Further, the monthly indoor temperature difference of the target building according to the original indoor set temperature and the changed indoor set temperature may be calculated to provide the results as a graph. Accordingly, the monthly indoor temperature difference according to the indoor set temperature is checked at a glance, assisting to set an optimal indoor set temperature value to maintain a more stable indoor temperature even during seasonal changes.

Further, a load calculation function for each hour of the day at the time of the maximum cooling and heating loads of the target building and a selective search function for each cooling and heating loads are provided.

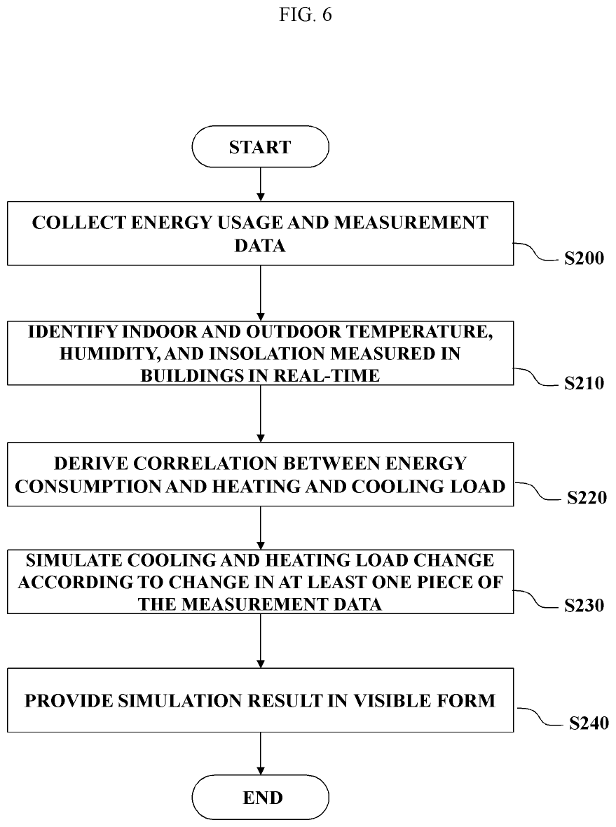

FIG. 6 is a flowchart of the simulation method of heating and cooling loads of a building according to an embodiment of the present disclosure.

The method performed in a simulation system for predicting heating and cooling loads of a building according to an embodiment collects pieces of measurement data including energy usage, electricity, air conditioning, crime prevention, and disaster prevention facility management data of a target building from a building energy management system (BEMS) (S200).

At this time, the building energy management system (BEMS) measurement data includes the envelope including the outer wall, window, and roof of the target building, and the inner wall/ceiling/floor structure, lighting, heating device, number of occupants, and heat source generated by intrusion outdoor air. However, it is not limited thereto. It is interpreted to cover all configurations of collecting data or information necessary to identify the heating and cooling loads of the target building.

Further, indoor and outdoor temperature, humidity, and insolation measured in the building are identified in real-time based on radiant time series (RTS)(S210).

Thereafter, a correlation deriving step derives a correlation between energy usage based on the BEMS measurement data collected by the collecting step and the cooling and heating loads according to indoor and outdoor temperature, humidity, and insolation identified by the identifying step (S220).

Further, the cause of the cooling and heating loads is derived, and the cause is identified based on the correlation derived in the correlation derivation step.

Further, a change in cooling and heating loads according to a change in at least one piece of the measured data is simulated based on the derived correlation with the cooling and heating loads and indoor and outdoor temperature, humidity and insolation (S230).

The simulation step calculates a comparison value of annual cooling and heating loads according to the performance change in the outer insulation of the target building according to building energy saving design standard to perform the simulation to predict the annual cooling and heating loads.

The change in envelope performance of the target building and the annual cooling and heating loads according to the change in envelope performance are calculated to provide the calculation as a simulation result.

Further, various factors that may act on the envelope change are reflected to provide a comparison result. Specifically, simulation results may be provided to allow performance comparison according to envelope insulation construction options such as envelope insulation type or insulation thickness.

Further, the simulating step calculates a comparison value of annual cooling and heating loads according to the performance change in the internal heating source of the building by identifying at least one of the pieces of data on lighting power, number of occupants, and calorific value of an electric heating device to perform the simulation to predict the annual cooling and heating loads.

When changing the use of a room, the load increase or decrease due to changes in lighting, number of occupants, and heating value of electric heaters may be calculated. Further, a load calculation function for each hour of the day at the time of the maximum cooling and heating loads of the target building and a selective search function for each cooling and heating load are provided.

The simulation step calculates a comparison value of annual cooling and heating loads according to the change in the indoor setting temperature value of the building to perform the simulation to predict the annual cooling and heating loads. Accordingly, the monthly indoor temperature difference according to the indoor set temperature is checked at a glance, assisting to set an optimal indoor set temperature value to maintain a more stable indoor temperature even during seasonal changes.

Then, the simulation result is provided to the user terminal in a visible form (S240).

Additionally, information on the correlation results derived in the correlation derivation step and the causal factor of the cooling and heating loads derived from the cause identification result are provided to the user terminal.

In one aspect of the present disclosure, the change in cooling and heating loads according to the change in the causal factor of the cooling and heating loads identified in the cause identification step is periodically monitored.

Further, the amount of change in cooling and heating loads for the amount of change in the causal factor of the cooling and heating loads is calculated, thereby deriving a quantitative relationship.

In one aspect, the information providing step zones a target building into physical spatial units, identifies a change in cooling and heating loads by time zone for each zoned spatial unit, and provides the information to the user terminal, and a cooling and heating load ratio to the average cooling and heating loads of the entire target building for each zoned spatial unit is calculated to provide the results to the user terminal.

The method may be implemented as an application or implemented in the form of program instructions that can be executed through various computer components and may be recorded on a computer-readable recording medium. The computer readable recording medium may include program instructions, data files, data structures, etc. alone or in combination.

Program instructions recorded on the computer-readable recording medium may be those specially designed and configured for the present disclosure, or those known and usable to those skilled in the art of computer software.

Examples of computer-readable recording media include magnetic media such as hard disks, floppy disks and magnetic tapes, optical recording media such as CD-ROMs and DVDs, and magneto-optical media such as floptical disks. and hardware devices specially configured to store and execute program instructions, such as ROM, RAM, flash memory, and the like.

Examples of program instructions include high-level language codes that can be executed by a computer using an interpreter or the like as well as machine language codes generated by a compiler. The hardware device may be configured to act as one or more software modules to perform processing according to the present disclosure and vice versa.

The above has been described with reference to embodiments, but those skilled in the art will understand that various modifications and changes can be made to the present disclosure without departing from the spirit and scope of the present disclosure described in the claims below.

What is claimed is:

1. A simulation system for predicting heating and cooling loads of a building, the system comprising:
a collection unit configured to collect pieces of measurement data including energy usage, electricity, air conditioning, crime prevention, and disaster prevention facility management data of a target building from a building energy management system (BEMS);
an identification unit configured to identify indoor and outdoor temperature, humidity, and insolation measured in the building in real time based on radiant time series (RTS) method;
a correlation derivation unit configured to derive a correlation between energy usage based on the BEMS measurement data collected by the collection unit and the cooling and heating loads according to indoor and outdoor temperature, humidity, and insolation identified by the identification unit;
a simulation unit configured to predict a change in cooling and heating loads according to a change in at least one of pieces of measurement data based on the correlation derived from the correlation derivation unit to perform a simulation; and
an information provision unit configured to provide a simulation result from the simulation unit in a visible form to a user terminal.

2. The system of claim 1, wherein the simulation unit calculates a comparison value of annual cooling and heating loads according to the performance change in the outer insulation of the target building according to building energy saving design standard to perform the simulation to predict the annual cooling and heating load.

3. The system of claim 1, wherein the simulation unit calculates a comparison value of annual cooling and heating loads according to the performance change in the internal heating source of the building by identifying at least one of pieces of data on lighting power, number of occupants, and calorific value of an electric heating device to perform the simulation to predict the annual cooling and heating load.

4. The system of claim 1, wherein the simulation unit calculates a comparison value of annual cooling and heating loads according to the change in the indoor setting temperature value of the building to perform the simulation to predict the annual cooling and heating load.

5. A method for performing a simulation system for predicting heating and cooling loads of a building, the method comprising:
a collecting step for collecting pieces of measurement data including energy usage, electricity, air conditioning, crime prevention, and disaster prevention facility management data of a target building from a building energy management system (BEMS);
an identifying step for identifying indoor and outdoor temperature, humidity, and insolation measured in the building in real time based on radiant time series (RTS) method;
a correlation deriving step for deriving a correlation between energy usage based on the BEMS measurement data collected by the collecting step and the cooling and heating loads according to indoor and outdoor temperature, humidity, and insolation identified by the identifying step;
a simulating step for predicting a change in cooling and heating loads according to a change in at least one of pieces of measurement data based on the correlation derived from the correlation deriving step to perform the simulation; and
an information providing step for providing a simulation result from the simulating step in a visible form to a user terminal.

6. The method of claim 5, wherein the simulating step calculates a comparison value of annual cooling and heating loads according to the performance change in the outer insulation of the target building according to building energy saving design standard to perform the simulation to predict the annual cooling and heating load.

7. The method of claim 5, wherein the simulating step calculates a comparison value of annual cooling and heating loads according to the performance change in the internal heating source of the building by identifying at least one of pieces of data on lighting power, number of occupants, and calorific value of an electric heating device to perform the simulation to predict the annual cooling and heating load.

8. The method of claim 5, wherein the simulating step calculates a comparison value of annual cooling and heating loads according to the change in the indoor setting temperature value of the building to perform the simulation to predict the annual cooling and heating load.
